(19) United States
(12) Patent Application Publication
(10) Pub. No.: US 2025/0320677 A1
(43) Pub. Date: Oct. 16, 2025

(54) BARRIER SYSTEM AND METHOD FOR INSTALLING A BARRIER SYSTEM

(71) Applicant: INERO AB, MÅNSARP (SE)

(72) Inventor: Ingvar NERO, MÅNSARP (SE)

(73) Assignee: INERO AB, MÅNSARP (SE)

(21) Appl. No.: 19/170,822

(22) Filed: Apr. 4, 2025

(30) Foreign Application Priority Data
Apr. 12, 2024 (EP) 24169858.8

(51) Int. Cl. E02B 3/10

(52) U.S. Cl. CPC E02B 3/106

(57) ABSTRACT

A barrier system comprises: a first sheet-metal and a second sheet-metal, each of the sheet-metals comprising a bottom portion configured to rest against a surface, and a wall portion extending from the bottom portion, wherein the first and second sheet-metals are arranged such that at least the two wall portions overlap each other in an overlapping region; and a clamping device comprising a first clamping portion extending along the wall portion of the first sheet-metal and configured to abut the wall portion of the first sheet-metal, a second clamping portion extending along the wall portion of the second sheet-metal and configured to abut the wall portion of the second sheet-metal, and an operable fixation member arranged such that when operated, the overlapping region is clamped between the first clamping portion and the second clamping portion.

### TECHNICAL FIELD

The present disclosure relates to a barrier system and a method for installing a barrier system.

### BACKGROUND

The number of flooding events are expected to increase in the future due to climate change. Floods may lead to property being damaged, human injuries, and even fatalities. The destruction floods bring causes damages that may lead to a great economic impact for individuals owning property, businesses and even entire countries.

One of the known solutions for preventing floods from reaching unwanted areas is the use of flood barriers. Flood barriers are a crucial tool for mitigating the impact of flooding and are designed to prevent the flood from reaching the area that is behind the flood barrier.

Flood barriers are used by, for example, individual property owners wanting to protect their property, businesses wanting to protect their industrial facilities, and emergency services when responding to natural disasters. However, flood barrier may be expensive and difficult to install, and it is therefore a need for a barrier system that is cost-efficient and easy to install.

### SUMMARY

It is an object of the present invention to provide an improved solution that alleviates the mentioned drawbacks with present devices. Furthermore, it is an object to provide a barrier system that is cost-efficient and provides an easy installation process.

The invention is defined by the appended independent claims, with embodiments being set forth in the appended dependent claims, in the following description and in the drawings.

According to a first aspect of the invention, there is provided a barrier system comprising a first and a second sheet-metal. Each of the sheet-metals comprises a bottom portion configured to rest against a surface, and a wall portion extending from the bottom portion. The first and second sheet-metals are arranged such that at least the two wall portions overlap each other in an overlapping region. The barrier system comprises a clamping device. The clamping device comprises a first clamping portion extending along the wall portion of the first sheet-metal and configured to abut the wall portion of the first sheet-metal. The first clamping portion comprises an upper portion and a lower portion. The clamping device comprises a second clamping portion extending along the wall portion of the second sheet-metal and configured to abut the wall portion of the second sheet-metal. The second clamping portion comprises an upper portion and a lower portion. The clamping device comprises an operable fixation member arranged such that when operated, the overlapping region is clamped between the lower portion of the first clamping portion and the lower portion of the second clamping portion. The operable fixation member is arranged to the upper portions of the first and second clamping portions, above the overlapping region of the sheet-metals.

The barrier system may be a flood barrier system configured to stop flooding. The barrier system may be cheaper and easier to install compared to other known flood barrier solutions. The barrier system may therefore be suitable to be used by individual property owners wanting to protect their property against flooding. Since it is a quick installation process, it may also be suitable to be used by emergency services. The barrier system may be configured to be arranged to different types of surfaces. The barrier system may be configured to be arranged on the ground. The barrier system may also be provided in a very easy manufacturing process, thereby making it cost-efficient. The barrier system may be particularly suitable for use in private households, to protect the house from e.g., high levels of water, since it may be provided at a low cost, is very easy to handle and assemble due to low weight and intuitive construction, and is easy to store.

The sheet-metals may be formed by a simple bending process from a sheet-metal blank, into the shape with a bottom portion and a wall portion. The clamping device may be formed out of a sheet-metal blank by a punching or cutting process, followed by a bending process. By forming the entire clamping device through such process, a very simple, cost-efficient, yet strong and easy to handle clamping device may be provided. No welding or other joining processes of different parts may be needed to form the clamping device.

The barrier system may be waterproof. The barrier system may be proofed against liquids and/or granular materials.

The clamping device may allow for an easy installation process since it would only be necessary to position the two sheet-metals on a surface such that the wall portions partly overlap and then use the clamping device to proof the barrier system.

By “the two wall portions overlap each other in an overlapping region” it may be meant that the two wall portions partly overlap with each other. A section of each of the two wall portions may not overlap.

The barrier system may be used to cover large areas. The second sheet-metal may overlap with a third sheet-metal and a second clamping device may be used on the overlap between the second sheet-metal and the third sheet-metal, and so on, to cover large areas with a chain of sheet-metals.

Operating the operable fixation member may proof the barrier system.

The wall portion of the sheet-metals may have a height of at least 20 cm, in some embodiments at least 30 cm, at least 40 cm, or between 40-60 cm.

The upper portions of the clamping portions may be portions not in contact with the sheet-metals when the clamping device is arranged to the sheet-metals. The operable fixation member may thereby extend through the clamping portions above the overlapping region of the sheet-metals, such that it does not extend through the sheet-metals. This may enable a simple configuration of the sheet-metals without the need of any opening through which the fixation member need to extend. It may further enable an easier assembly of the clamping device to the sheet-metals.

The first clamping portion and the second clamping portion extend longitudinally. The clamping device comprises a middle portion arranged between a lateral edge of the first clamping portion and a lateral edge of the second clamping portion.

The first clamping portion's longitudinal extension may be substantially the same as the extension along the wall portion of the first sheet-metal. The second clamping portion's longitudinal extension may be substantially the same as the extension along the wall portion of the second sheet-metal.

The middle portion may be arranged between the lateral edge of the first clamping portion and the lateral edge of the second clamping portion such that it couples the two clamping portions together. The middle portion may be directly arranged to the lateral edge of the first clamping portion and to the lateral edge of the second clamping portion. When the clamping device is arranged to the wall portions, the middle portion may extend substantially transverse to the longitudinal extensions of the two clamping portions

The middle portion couples the first clamping portion to the second clamping portion. The middle portion and the two clamping portions are shaped such that when the operable fixation member is operated, the overlapping region is first clamped between lower portions of the two clamping portions such that the clamping device is tapered in a direction from the middle portion towards the two lower portions.

The clamping device may be tapered such that the clamping device is conical shaped. The clamping device being tapered when the operable fixation member is operated may provide a more powerful clamping against the overlapping region.

The two clamping portions may be bent when the operable fixation member is operated. The two clamping portions being bent when the operable fixation member is operated may provide a more powerful clamping against the overlapping region.

A gap may be provided between an upper section of the first clamping portion and an upper section of the second clamping portion when the overlapping region is clamped between the two lower sections. The gap may be positioned above the wall portions of the two sheet-metals.

The first clamping portion may comprise a first pair of parallel and equally long opposing side walls. The second clamping portion may comprise a second pair of parallel and equally long opposing side walls. The middle portion may have a length which may be greater than the sum of a width of a side wall of the first pair of side walls and a width of a side wall of the second pair of side walls. By width of a side wall it may be meant the extension of the side wall in a direction transvers to the longitudinal extension of the clamping portion.

The pair of side walls of each of the two clamping portions may extend towards the sheet-metals. The side walls may be arranged perpendicular to the wall portions of the two sheet-metals. The pair of side walls of each of the two clamping portions may be arranged along respective clamping portion's longitudinal extension. The two clamping portions may be U-shaped.

Longitudinal edges of the pair of side walls of each of the two clamping portions may clamp against the overlapping region when the operable fixation member is operated. A more powerful clamping may be provided by the longitudinal edges clamping against the overlapping region. The clamping being more powerful may provide better proofing properties to the barrier system.

Each of the clamping portions may further comprise a center section. The pair of side walls of each of the two clamping portions may extend away from respective center section. The pair of side walls of each of the two clamping portions may extend from respective center section in a direction perpendicular to the center section. The center section may be substantially parallel to the wall portions of the two sheet-metals when arranged thereto. The center section may not abut the overlapping region.

The length of the middle portion being greater than the sum of the width of a side wall of the first pair of side walls and the width of a side wall of the second pair of side walls may provide a gap between an upper section of the first clamping portion and an upper section of the second clamping portion. The upper sections may be sections of the clamping portions, may be sections adjacent to the middle portion, and may be at least partly between the fixation member and the middle portion. The gap may be tapering in direction towards the lower sections of the clamping portions.

The length of the middle portion being greater than the sum of a width of a side wall of the first pair of side walls and the width of a side wall of the second pair of side walls may cause the overlapping region being clamped, in an initial state when the fixation member is operated to clamp the overlapping region, between lower sections of each of the two clamping portions while a gap is provided between the upper sections of the two clamping portions when the operable fixation member is operated on. When the operable fixation member is further operated to cause stronger clamping of the overlapping region, clamping may be provided such that the gap at the upper sections of the clamping portions is reduced, minimized or completely closed. This may be provided by the clamping portions being at least slightly bent when operating the fixation member further. This may provide a strong clamping over the complete longitudinal extension of the clamping portions being in contact with the wall portions at the overlapping region.

The length of the middle portion being greater than the sum of a width of a side wall of the first pair of side walls and the width of a side wall the second pair of side walls may cause the clamping device to be tapered in a direction from the middle portion towards the two lower sections.

The overlapping region may be clamped between the entire lower sections of the two clamping portions, being the sections of the clamping portions being in contact with the wall portions, when the operable fixation member has reached a final clamping state.

The wall portion may extend orthogonally from the bottom portion of each of the two sheet-metals.

The wall portion may extend orthogonally from the bottom portion of each of the two sheet-metals such that the each of the two sheet-metals are L-shaped. The height of the wall portion may determine how much flooding that the barrier system prevents.

Each of the two clamping portions may comprise a hole. The operable fixation member may extend through the holes of the two clamping portions and may be configured to, when operated, press the two clamping portions towards each other.

The operable fixation member may be a screw or a bolt and the fixation member may be operated by rotation.

A threaded nut may be arranged on the screw or bolt. The screw or bolt may be arranged in the holes of the two clamping portions. The threaded nut may be arranged on the screw or bolt such that the threaded nut facilitates the clamping of the overlapping region.

The barrier system may comprise a support leg fastened to the clamping device.

The support leg may provide better stability to the barrier system by extending from the clamping device to the surface at which the barrier system is arranged. The support leg may enable the barrier system to withstand greater amount of pressure from flooding and the like.

The support leg may be arranged on a rear side of the barrier system. By “a rear side” it may be meant a side of the two wall portions where the two bottom portions are not located. The support leg may be arranged to one of the clamping portions, i.e., the clamping portion being located at said rear side of the wall portions. The support leg may be attached to the operable fixation member. The support leg may thereby be fixed to the clamping device by the same operation of the fixation member as for clamping the wall portions. The support leg may comprise a hole through which a screw or bolt of the fixation member may extend. From a fixation point of the support leg, at which it may be arranged to the clamping device, the support leg may extend with an angle to the clamping device of between 30-60 degrees.

The barrier system may comprise a sealing member arranged between the first clamping portion and the wall portion of the first sheet-metal, and a sealing member arranged between the second clamping portion and the wall portion of the second sheet-metal.

The sealing member may be formed out of rubber. The sealing member may be a rubber strip. The sealing member may be arranged on the clamping device.

The sealing member may facilitate the proofing of the barrier system. The barrier system may improve its proofing properties by using the sealing member.

The barrier system may comprise a sealing member arranged in the overlapping region between the wall portion of the first sheet-metal and the wall portion of the second sheet-metal.

The barrier system may improve its proofing properties by arranging the sealing member in the overlapping region between the two sheet-metals.

The two sheet-metals may be arranged such that the two bottom portions overlap each other in a second overlapping region.

The two bottom portions overlapping each other may facilitate the proofing of the barrier system. The water weight presses down on the second overlapping region during flooding which may enable the two bottom portions to facilitate the proofing of the barrier system.

The barrier system may comprise a sealing member arranged in the second overlapping region between the bottom portion of the first sheet-metal and the bottom portion of the second sheet-metal.

The sealing member arranged in the second overlapping region may further facilitate the proofing of the barrier system.

The clamping device may be formed out of bended sheet-metal.

The clamping device may be cut out of sheet-metal, or punched, and then bent to form the clamping device. Cutting, punching and bending sheet-metals is a cheap and easy manufacturing method. The clamping device may not be welded. The clamping device may be formed out of galvanized sheet-metal. Galvanized sheet-metal is sturdy and persists well against water.

The first and the second sheet-metals may be bended sheet-metals.

The two sheet-metals may be cut out of sheet-metal and then bent to form the bottom portion and the wall portion. Cutting and bending sheet-metals is a cheap and easy manufacturing method. The two sheet metals may not be welded. The two sheet-metals may be formed out of galvanized sheet-metal. Galvanized sheet-metal is sturdy and persists well against water.

According to another aspect, there is provided a method for installing a barrier system. The method comprises the steps of arranging a first sheet-metal to a surface, arranging a second sheet-metal to the surface such that at least a wall portion of the second sheet-metal overlaps with a wall portion of the first sheet-metal in an overlapping region, arranging a clamping device such that a first clamping portion abut the wall portion of the first sheet-metal and a second clamping portion abut the wall portion of the second sheet-metal, and operating a fixation member arranged on the clamping device such that the overlapping region is clamped between the first clamping portion and the second clamping portion.

The method for installing a barrier system may be a simple and fast method. The method may be used by individuals wanting to protect their property against flooding and rescue services that need to have a quick way of stopping flooding. It may be a straightforward method that does not require any complex instructions to be able to do the installation. The sheet-metals and/or the clamping device used in the method may be provided as sheet-metals and/or clamping devices according to any of the embodiments described herein.

### BRIEF DESCRIPTION OF THE DRAWING

The invention will in the following be described in more detail with reference to the enclosed drawings, wherein:

FIG. 1 shows a perspective view of a rear side of a barrier system according to an embodiment.

FIG. 2 shows a perspective view of a barrier system according to an embodiment.

FIG. 3 shows a front view of a clamping device according to an embodiment.

FIG. 4 shows a cross section view of a clamping device according to an embodiment.

FIG. 5 shows a front view of a clamping device being operated according to an embodiment.

FIG. 6 shows a side view of a barrier system according to an embodiment.

### DESCRIPTION OF EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

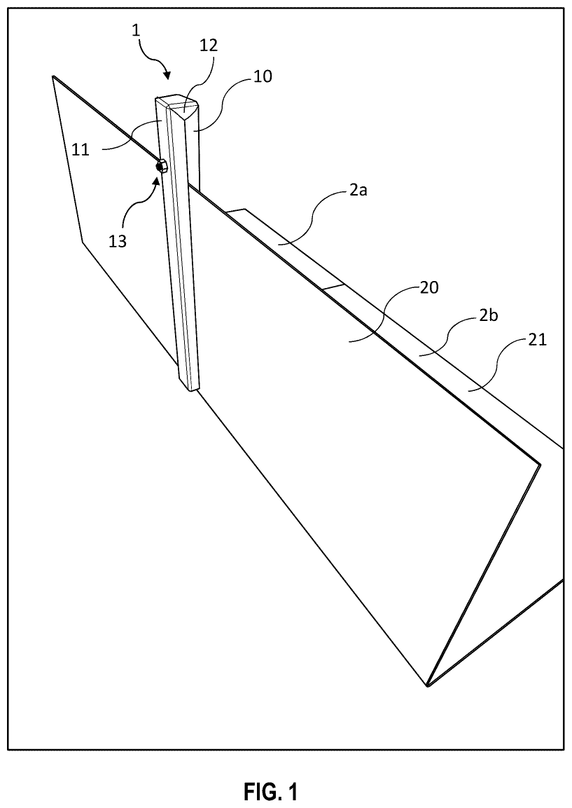

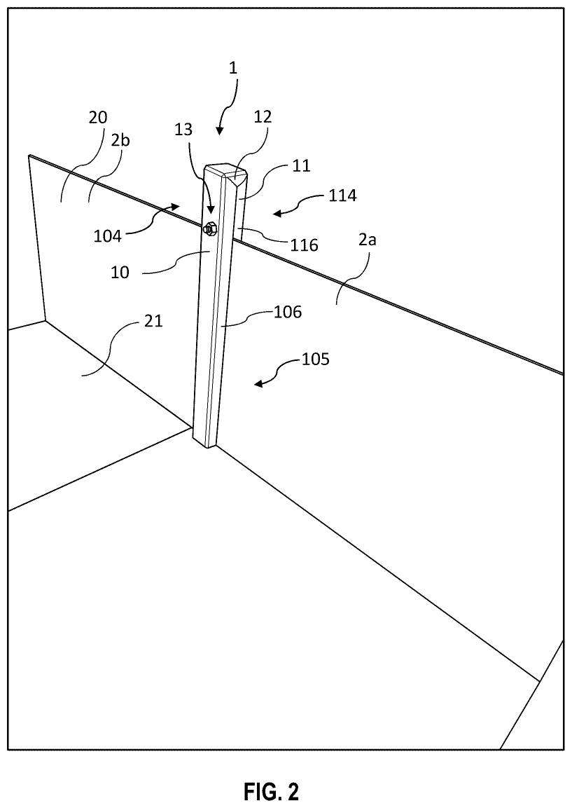

FIGS. 1, 2 and 6 schematically illustrate a barrier system. The barrier system may be a flooding barrier system. The barrier system may be configured to be arranged to different types of surfaces. The barrier system may be configured to be arranged on the ground. The barrier system may be waterproof. The barrier system may be proofed against liquids and/or granular materials.

The barrier system comprises two sheet-metals 2a, 2b. Each of the two sheet-metals 2a, 2b comprises a wall portion 20. Each of the two sheet-metals 2a, 2b comprises a bottom portion 21. The wall portion 20 of each sheet-metal 2a, 2b may extend from respective bottom portion 21. The wall portion 20 of each sheet-metal 2a, 2b may extend orthogonally from respective bottom portion 21. The sheet-metals 2a, 2b may be arranged such at least the two wall portions 20 overlap each other in an overlapping region.

The bottom portion 21 is configured to rest against a surface (30). The two bottom portions 21 may overlap each other in a second overlapping region.

The two sheet-metals 2a, 2b may be L-shaped. The two sheet-metals 2a, 2b may be bended sheet-metals. The two sheet-metals 2a, 2b may be cut out of sheet-metal and then bent to form the bottom portion 21 and the wall portion 20. The two sheet-metals 2a, 2b may not be welded. The two sheet-metals 2a, 2b may be formed out of galvanized sheet-metal.

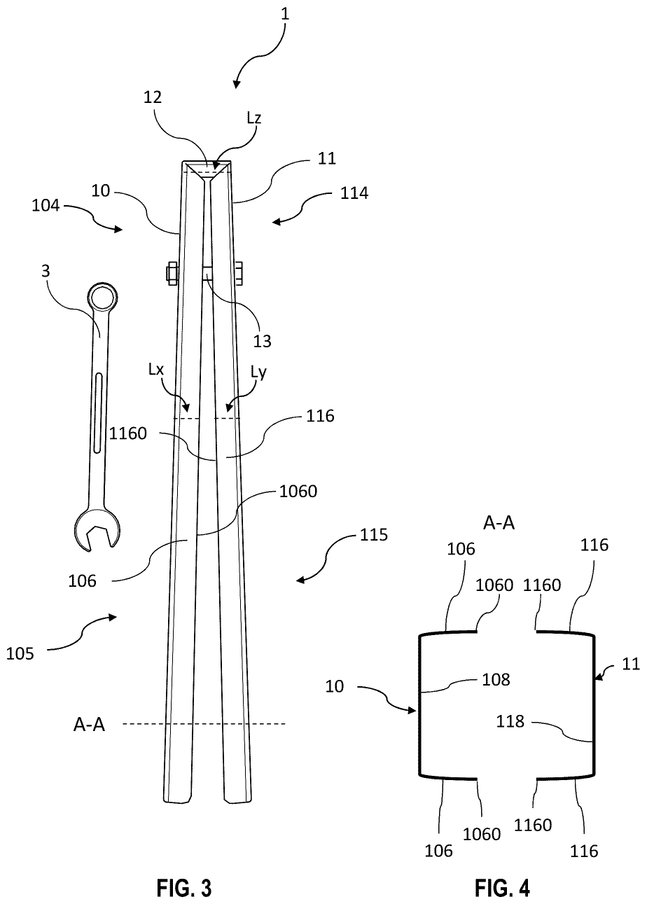

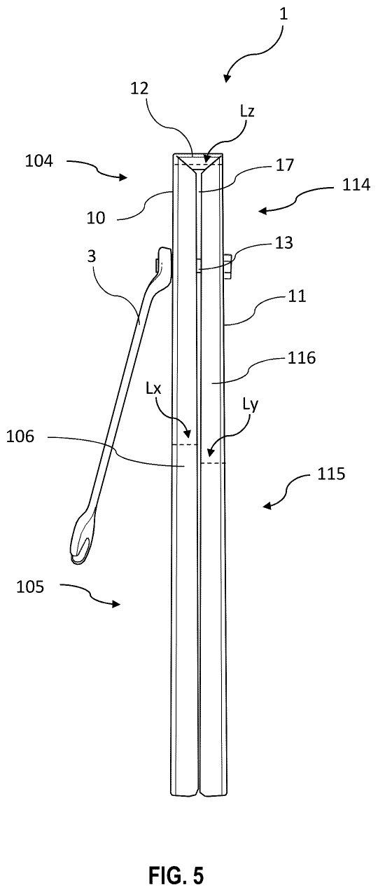

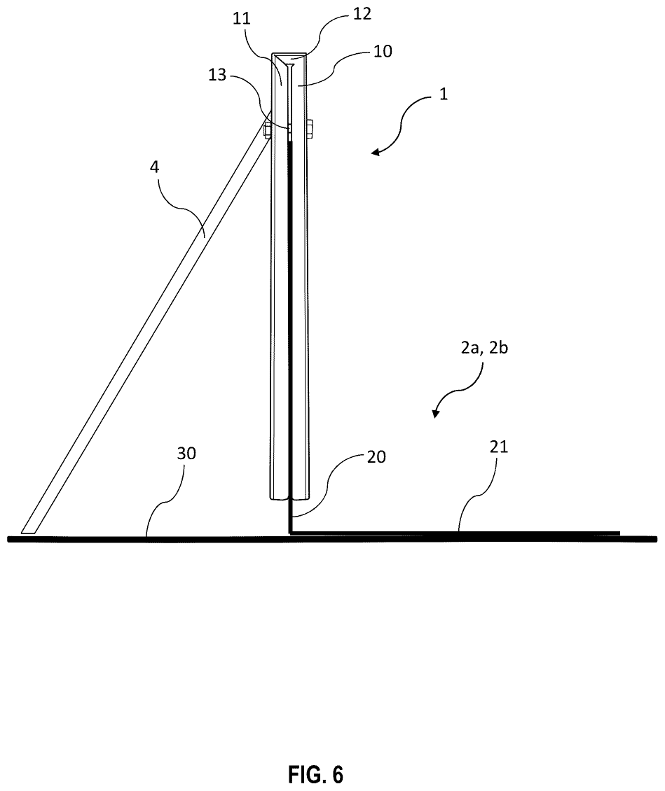

The barrier system comprises a clamping device 1. FIGS. 3 and 5 schematically illustrate the clamping device 1. FIG. 4 schematically illustrates a cross section A-A of the clamping device 1. The clamping device 1 comprises a first clamping portion 10. The first clamping portion 10 extends along the wall portion 20 of the first sheet-metal 2a. The first clamping portion 10 is configured to abut the wall portion 20 of the first sheet metal 2a. The first clamping portion 10 may extend longitudinally. The longitudinal extension may be substantially the same as the extension along the wall portion 20 of the first sheet-metal 2a.

The first clamping portion 10 may comprise a first pair of parallel and equally long opposing side walls 106. The first pair of side walls 106 may be configured to extend towards the wall portions 20 of the two sheet-metals 2a, 2b. The first pair of side walls 106 may be configured to be arranged perpendicular to the wall portions 20 of the two sheet-metals 2a, 2b. The first pair of side walls 106 may be arranged along the first clamping portion's 10 longitudinal extension.

The first pair of side walls 106 may comprise longitudinal edges 1060. The longitudinal edges 1060 of the first pair of side walls 106 may be configured to abut the wall portion 20 of the first sheet-metal 2a.

The first clamping portion 10 may be U-shaped.

The first clamping portion 10 may comprise a center section 108. The first pair of side walls 106 may extend away from the center section 108 of the first clamping portion 10. The first pair of side walls 106 may extend from the center section 108 of the first clamping portion 10 in a direction perpendicular to the center section 108 of the first clamping portion 10. The center section 108 of the first clamping portion 10 may be substantially parallel to the wall portions 20 of the two sheet-metals 2a, 2b when arranged thereto. The center section 108 of the first clamping portion 10 may not abut the overlapping region.

The clamping device 1 comprises an operable fixation member 13.

The first clamping portion 10 may comprise a lower section 105. The lower section 105 may be positioned below the operable fixation member 13 when the clamping device 1 is arranged to the wall portions 20. The first clamping portion 10 may comprise an upper section 104. The upper section 104 may be positioned above the operable fixation member 13 when the clamping device 1 is arranged to the wall portions 20.

The first clamping portion 10 may comprise a hole.

The clamping device 1 comprises a second clamping portion 11. The second clamping portion 11 extends along the wall portion 20 of the second sheet-metal 2b. The second clamping portion 11 is configured to abut the wall portion 20 of the second sheet-metal 2b. The second clamping portion 11 may extend longitudinally. The longitudinal extension may be substantially the same as the extension along the wall portion 20 of the second sheet-metal 2b.

The second clamping portion 11 may comprise a second pair of parallel and equally long opposing side walls 116. The second pair of side walls 116 may be configured to extend towards the wall portions 20 of the two sheet-metals 2a, 2b. The second pair of side walls 116 may be configured to be arranged perpendicular to the wall portions 20 of the two sheet-metals 2a, 2b. The second pair of side walls 116 may be arranged along the second clamping portion's 11 longitudinal extension.

The second pair of side walls 116 may comprise longitudinal edges 1160. The longitudinal edges 1160 of the second pair of side walls 116 may be configured to abut the wall portion 20 of the second sheet-metal 2b.

The second clamping portion 11 may be U-shaped.

The second clamping portion 11 may comprise a center section 118. The second pair of side walls 116 may extend away from the center section 118 of the second clamping portion 11. The second pair of side walls 116 may extend from the center section 118 of the second clamping portion 11 in a direction perpendicular to the center section 118 of the second clamping portion 11.

The center section 118 of the second clamping portion 11 may be substantially parallel to the wall portions 20 of the two sheet-metals 2a, 2b when arranged thereto. The center section 118 of the second clamping portion 11 may not abut the overlapping region.

The second clamping portion 11 may comprise a lower section 115. The lower section 115 may be positioned below the operable fixation member 13 when the clamping device 1 is arranged to the wall portions 20. The second clamping portion 11 may comprise an upper section 114. The upper section 114 may be positioned above the operable fixation member 13 when the clamping device 1 is arranged to the wall portions 20.

The second clamping portion 11 may comprise a hole.

The operable fixation member 13 may be located at the upper sections 104, 114 of the clamping portions 10, 11. When the clamping device 1 is arranged to the sheet-metals 2a, 2b, the operable fixation member 13 is located above the sheet-metals 2a, 2b, thereby not extending through any of the sheet-metals 2a, 2b. The operable fixation member 13 may extend through the respective holes in the first and second clamping portions 10, 11.

The clamping device 1 may comprise a middle portion 12. The middle portion 12 may be arranged between a lateral edge of the first clamping portion 10 and a lateral edge of the second clamping portion 11. The middle portion 12 may be arranged such that it couples the two clamping portions 10, 11 together. The middle portion 12 may be directly arranged to the lateral edge of the first clamping portion 10 and the lateral edge of the second clamping portion 11.

The middle portion 12 may extend substantially transverse to the longitudinal extensions of the two clamping portions 10, 11 when the clamping device 1 is arranged to the wall portions 20.

The middle portion 12 may have a U-shape, similarly to the clamping portions 10, 11. The middle portion 12 may have a center section and two side walls extending perpendicular from the center section. The side walls of the middle portion 12 may have a corresponding width as the width of each of the side walls 106, 116 of the clamping portions 10, 11.

The middle portion 12 may have a length Lz which is greater than the sum of a width Lx of a side wall of the first pair of side walls 106 and a width Ly of a side wall of the second pair of side walls 116.

The clamping device 1 may comprise a gap 17. The gap 17 may be provided by the length Lz of the middle portion 12 being greater than the sum of the width Lx of a side wall of the first pair of side walls 106 and the width Ly of a side wall of the second pair of side walls 116.

The gap 17 may be arranged between the upper section 104 of the first clamping portion 10 and the upper section 114 of the second clamping portion 11. The upper sections 104, 114 may be sections of the clamping portions 10, 11. The upper sections 104, 114 may be sections adjacent to the middle portion 12.

The gap 17 may be configured to be arranged above the wall portions 20 of the two sheet-metals 2a, 2b, at least when the clamping device 1 is arranged to the sheet-metals 2a, 2b.

The gap 17 may be tapering in direction towards the lower sections 105, 115 of the clamping portions 10, 11.

The operable fixation member 13 is arranged such that when operated the overlapping region is clamped between the first clamping portion 10 and the second clamping portion 11. The operable fixation member 13 may, when operated, bend the two clamping portions 10, 11. The longitudinal edges 1060 of the first pair of side walls 106 and the longitudinal edges 1160 of the second pair of side walls 116 may clamp against the overlapping region when the operable fixation member 13 is operated.

The operable fixation member 13 may be arranged such that when further operated, the gap 17 between the upper sections 104, 114 of the clamping portions 10, 11 may be reduced, minimized or completely closed. The operable fixation member 13 may, when further operated, bend the two clamping portions 10, 11.

The two clamping portions 10, 11 may be shaped such that, when the operable fixation member 13 is operated, the overlapping region may first be clamped between the lower sections 105, 115 of the clamping device 1 such that the clamping device 1 is tapered in a direction from the middle portion 12 towards the lower sections 105, 115.

The operable fixation member 13 may be arranged such that, when reaching a final clamping state, the overlapping region may be clamped between the entire lower sections 105, 115 of the two clamping portions 10, 11, being the sections of the clamping portions 10, 11 being in contact with the wall portions 20.

The operable fixation member 13 may extend through the holes of the two clamping portions 10, 11. The operable fixation member 13 may be configured to, when operated, press the two clamping portions 10, 11 towards each other.

The operable fixation member 13 may be a screw or a bolt. A threaded nut may be arranged on the screw or bolt. The threaded nut may be arranged on the screw or bolt such that the threaded nut facilitates the clamping of the overlapping region. The screw or bolt may be arranged in the holes of the two clamping portions 10, 11. The operable fixation member 13 may be operated by rotation. The screw or bolt may be operated by rotation. The screw or bolt may be configured to be operated by rotation by a wrench 3.

The upper sections 104, 114 of the two clamping portions 10, 11 may be at least partly between the operable fixation member 13 and the middle portion 12.

The gap 17 may be provided when the overlapping region is clamped between the two lower sections 105, 115.

The clamping device 1 may be conical shaped. The clamping device 1 may be tapered in a direction from the middle portion 12 towards the lower sections 105, 115.

The clamping device 1 may be formed out of bended sheet-metal. The clamping device 1 may be cut out of sheet-metal, or punched, and then bent to form the clamping device 1. The clamping device 1 may not be welded. The clamping device 1 may be formed out of galvanized sheet-metal. The side walls 106, 116 of the first and second clamping portions 10, 11, as well as side walls of the middle portion 12, may be formed by bending operations from a sheet-metal blank extending in a plane of the central sections 108, 118 of the clamping portions 10, 11 and the middle portion 12. Before being bent into forming the first and second clamping portions 10, 11 and the middle portion 12, the center sections of said portions may extend in a common plane. By having a configuration enabling a manufacturing by only cutting or punching and bending, the clamping device 1 may be very easy to manufacture.

As further seen in FIG. 6, the barrier system may comprise a support leg 4. The support leg 4 may be fastened to the clamping device 1. The support leg 4 may be configured to extend towards the surface 30 on which the barrier system is arranged, in order to improve stability of the barrier system. The support leg 4 may be arranged on a rear side of the barrier system. The support leg 4 may be arranged to one of the clamping portions 10, 11. The support leg 4 may be attached to the operable fixation member 13. The support leg 4 may comprise a hole through which a screw or bolt of the fixation member 13 may extend. From a fixation point of the support leg 4, at which it may be arranged to the clamping device 1, the support leg 4 may extend with an angle to the clamping device 1 of between 30-60 degrees.

The barrier system may comprise a sealing member. The sealing member may be arranged between the first clamping portion 10 and the wall portion 20 of the first sheet-metal 2a. The sealing member may be arranged between the second clamping portion 11 and the wall portion 20 of the second sheet-metal 2b. The sealing member may be arranged on the clamping device 1. The sealing member may be arranged in the overlapping region between the wall portion 20 of the first sheet-metal 2a and the wall portion 20 of the second sheet-metal 2b. The sealing member may be arranged in the second overlapping region between the bottom portion 21 of the first sheet-metal 2a and the bottom portion 21 of the second sheet-metal 2b.

The sealing member may be formed out of rubber. The sealing member may be a rubber strip.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A barrier system comprising:
a first sheet-metal and a second sheet-metal, each of the sheet-metals comprising:
a bottom portion configured to rest against a surface, and
a wall portion extending from the bottom portion,
wherein the first and second sheet-metals are arranged such that at least the two wall portions overlap each other in an overlapping region; and
a clamping device comprising:
a first clamping portion extending along the wall portion of the first sheet-metal and configured to abut the wall portion of the first sheet-metal, wherein the first clamping portion comprises an upper portion and a lower portion,
a second clamping portion extending along the wall portion of the second sheet-metal and configured to abut the wall portion of the second sheet-metal, wherein the second clamping portion comprises an upper portion and a lower portion, and
an operable fixation member arranged such that when operated, the overlapping region is clamped between the lower portion of the first clamping portion and the lower portion of the second clamping portion, wherein the operable fixation member is arranged to the upper portions of the first and second clamping portions, above the overlapping region of the sheet-metals,
wherein the first clamping portion and the second clamping portion extend longitudinally and the clamping device further comprises a middle portion arranged between a lateral edge of the first clamping portion and a lateral edge of the second clamping portion,
wherein the middle portion couples the first clamping portion to the second clamping portion, and the middle portion and the two clamping portions are shaped such that when the operable fixation member is operated, the overlapping region is first clamped between lower portions of the two clamping portions such that the clamping device is tapered in a direction from the middle portion towards the two lower portions.

2. The barrier system according claim 1, wherein the first clamping portion comprises a first pair of parallel and equally long opposing side walls, and
the second clamping portion comprises a second pair of parallel and equally long opposing side walls,
wherein the middle portion has a length which is greater than the sum of a width of a side wall of the first pair of side walls and a width of a side wall of the second pair of side walls.

3. The barrier system according to claim 1, wherein the wall portion extends orthogonally from the bottom portion of each of the two sheet-metals.

4. The barrier system according to claim 1, wherein each of the two clamping portions includes a hole, and the operable fixation member extends through the holes of the two clamping portions and is configured to, when operated, press the two clamping portions towards each other.

5. The barrier system according to claim 1, wherein the operable fixation member is a screw or a bolt and the fixation member is operated by rotation.

6. The barrier system according to claim 1, further comprising a support leg fastened to the clamping device.

7. The barrier system according to claim 1, further comprising a sealing member arranged between the first clamping portion and the wall portion of the first sheet-metal, and a sealing member arranged between the second clamping portion and the wall portion of the second sheet-metal.

8. The barrier system according to claim 1, further comprising a sealing member arranged in the overlapping region between the wall portion of the first sheet-metal and the wall portion of the second sheet-metal.

9. The barrier system according to claim 1, wherein the two sheet-metals are arranged such that the two bottom portions overlap each other in a second overlapping region.

10. The barrier system according to claim 1, further comprising a sealing member arranged in the second overlapping region between the bottom portion of the first sheet-metal and the bottom portion of the second sheet-metal.

11. The barrier system according to claim 1, wherein the clamping device is formed out of bended sheet-metal.

12. The barrier system according to claim 1, wherein the first and the second sheet-metals are bended sheet-metals.

13. A method for installing a barrier system, the method comprising the steps of:
arranging a first sheet-metal to a surface,
arranging a second sheet-metal to the surface such that at least a wall portion of the second sheet-metal overlaps with a wall portion of the first sheet-metal in an overlapping region,
arranging a clamping device such that a lower portion of a first clamping portion of the clamping device abuts and extends longitudinally along the wall portion of the first sheet-metal and a lower portion of a second clamping portion of the clamping device abuts and extends longitudinally along the wall portion of the second sheet-metal, the first and second clamping portions extending from a middle portion arranged between lateral edges of the first and second clamping portions coupling the two clamping portions to each other, and
operating a fixation member arranged to an upper portion of the first clamping portion and an upper portion of the second clamping portion of the clamping device such that the overlapping region is clamped between the lower portion of the first clamping portion and the lower portion of the second clamping portion, and such that the operable fixation member is arranged to the upper portions of the first and second clamping portions above the overlapping region of the sheet-metals, wherein the operation of the fixation member provides that the overlapping region is first clamped between the lower portions of the two clamping portions such that the clamping device is tapered in a direction from the middle portion towards the two lower portions.
